(19) United States
(12) Patent Application Publication
(10) Pub. No.: US 2009/0162519 A1
(43) Pub. Date: Jun. 25, 2009

(54) SWEET FOOD COMPOSITION WITH LOW SUGAR CONTENTS

(75) Inventors: David Philippe Labbe, Lausanne (CH); Nathalie Marguerite Claire Martin, Lausanne (CH)

Correspondence Address: K&L Gates LLP, P.O. Box 1135, CHICAGO, IL, 60690, US

(73) Assignee: NESTEC S.A., Vevey (CH)

(21) Appl. No.: 12/297,679

(22) PCT Filed: Jan. 22, 2007
(86) PCT No.: PCT/EP07/00510

§ 371 Date: Jan. 21, 2009

(30) Foreign Application Priority Data
Mar. 29, 2006 (EP) 06111913.7

(51) Int. Cl. A23C 23/00; A23L 1/221

(52) U.S. Cl. 426/583; 426/650

(57) ABSTRACT

The present invention relates to a food composition comprising at least one natural and/or artificial sugar that is present in said composition at a suprathreshold concentration, characterized in that said food composition further comprises at least one sweet-enhancing ingredient chosen from the list comprising: benzaldehyde, ethylbutyrate, furaneol, vanillin, isoamylacetate, or a combination thereof, said ingredient being present in said composition at a concentration not exceeding 2.5·10⁻⁵ mg/l.

The present invention relates to a food composition comprising at least one sugar at suprathreshold but very low concentration, that further comprises one ingredient to enhance the perception of sweetness.

In the recent years, it was found that food products containing added sugar, like for example soda and sugar-sweetened beverage has an impact on consumer's body weight, especially children's body weight. These findings show that for each additional daily serving of a sugar-sweetened soft drink, the incidence of obesity was significantly increased.

The studies that have been conducted show that soft drinks are currently the leading source of added sugars in the daily diet of consumers in developed—and sometimes developing—countries. These drinks may be easy to over-consume, because calories in liquid form seem to be less satiating, or less filling, than calories in solid form.

It is therefore crucial to find a way to keep the sweet taste in some products, while reducing their real contents in sugar (added sugar).

The present invention addresses the problems set out above with a food composition comprising at least one natural and/or artificial sugar that is present in said composition at a suprathreshold concentration.

According to the invention, said food composition is characterized in that it further comprises at least one sweet-enhancing ingredient chosen from the list comprising: benzaldehyde, ethylbutyrate, furaneol, vanillin, isoamylacetate, or a combination thereof, said ingredient being present in said composition at a concentration not exceeding 2.5·10−5 mg/l.

Surprisingly, it was found that the combination of a sugar at suprathreshold concentration, with one predetermined compound chosen in the list cited above, that is present in the food at subthreshold concentration, enhances the overall perception of the sweetness in the food, although the contents of added sugar is dramatically decreased compared to a food composition that does not contain the sweet-enhancing component.

Preferably, said sugar is chosen in the list comprising: simple sugars, hydrogentated sugars, chlorodeoxy sugars, terpenoids or their glycosides, dihydrochalcones, peptides, proteins, nitroanilines, sulphamates oximes, isocoumarins, saccharins, acesulphames, tryptophanes, ureas, or a combination thereof.

Also preferably, said sweet-enhancing ingredient is present in said composition at a concentration of between 1.5·10−6 mg/l and 2.5·10−5 mg/l.

Advantageously, said sweet-enhancing ingredient is ethyl butyrate.

In another preferred embodiment of the invention, said sugar is present in said composition at a concentration not exceeding 50 g/l, but such that said sugar can be tasted consciously by a consumer.

The food composition according to the present invention can either be aromatised water, or a chilled dairy plain yoghurt.

The invention will now be described in further details, by describing three specific experiments wherein food compositions according to the invention were prepared and tested. This detailed description of specific examples and experiments of the invention are made with reference to the accompanying figures which are as follows.

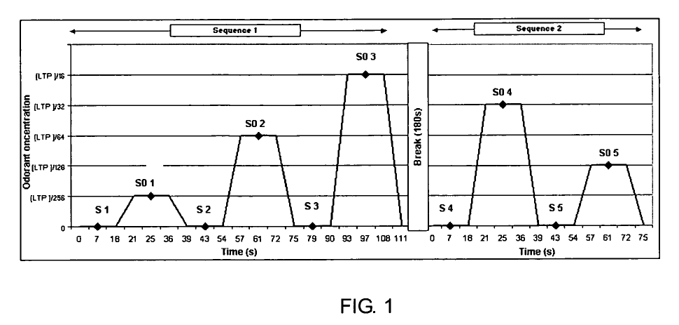

FIG. 1 is a schematic diagram of the liquid flow composition evaluated overtime in sweetness intensity. LTP (Lowest Threshold of the Panel) is a composition comprising 3.90⁻⁰⁴ ppm for ethyl butyrate. S is the sweetness of a sucrose solution without odorant. SO is the sweetness of sucrose solution with odorant.

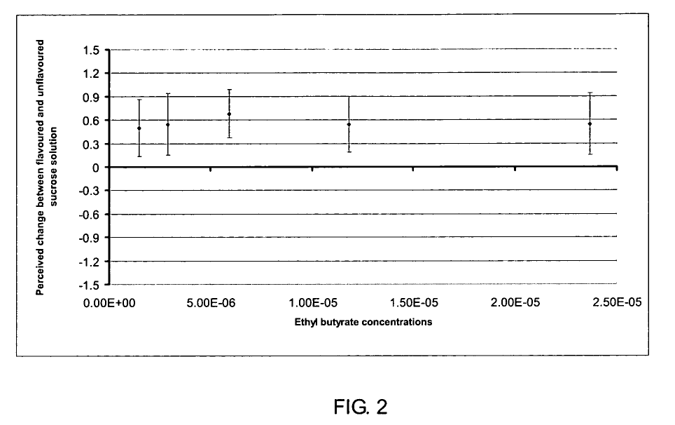

FIG. 2 is a schematic representation of the impact of subthreshold ethyl butyrate concentrations (X-axis) on sweetness (Y-axis) of the 15 g/l sucrose solutions.

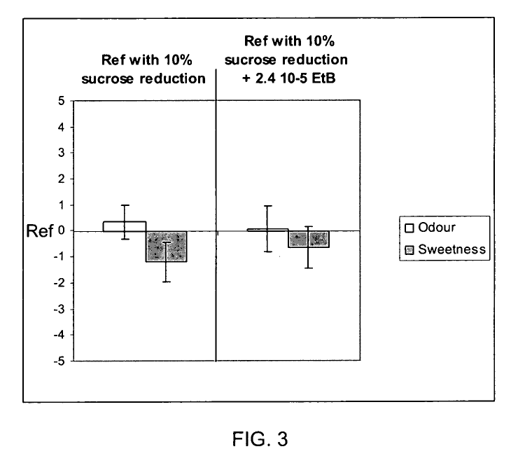

FIG. 3 is a schematic representation of the impact of a subthreshold ethyl butyrate on sweetness of a sweet commercial flavoured mineral water beverage reduced in sucrose by 10%.

First of all, for the sake of clarity in the body of the following description, a few definitions are now proposed.

By “suprathreshold concentration”, it is meant a concentration perceptible by subjects because said concentration is above the detection threshold concentration, i.e. conscious perception.

By “subthreshold concentration”, it is meant for a concentration not perceptible by subjects because it is below the detection threshold concentration, i.e. unconscious perception.

By “panel detection threshold”, it is meant that the concentration was defined as the lowest individual detection threshold concentration perceived among the panel.

Pioneer studies on interaction at a suprathreshold level between odour and taste perception showed that subjects attribute a taste to aqueous solution flavoured with an odorant, by using static sensory measurement or Time-Intensity evaluation. Conversely, retronasal olfactory perception can also be modulated by taste perception.

Perceptual similarity between an odorant and a tastant in mixture seemed to be a good predictor of taste intensity change. Indeed an odour can acquire a taste quality when the odour-taste pair is congruent, meaning present in food commonly experienced by consumers. Congruency is defined as “the extent to which two stimuli are appropriate for combination in a food product”. For instance pineapple flavouring can enhance perceived sweetness of a model solution. In real food context, strawberry odour enhances whipped cream sweetness whereas peanut butter does not affect sweetness rating. Another study showed that vanilla flavouring enhances perceived sweetness when added in milk among children and adults. Besides, it has also been shown that an odour can also decrease taste intensity when the odour-taste pair is not congruent in food. In this experiment, caramel odour, related to sweet taste, decreased sour taste intensity. Functional Resonance Magnetic Imagery (FMRI) results also provided evidence for the convergence of taste and olfactory stimuli in the lateral anterior part of the orbitofrontal cortex to produce flavour in humans.

More recently, it was uncovered that the effect of stimuli at a subthreshold concentration has also an impact on perception. Integration at a subthreshold level of congruent taste and olfactory stimuli presented orthonasally was demonstrated using a variant of the two-alternative forced choice method.

Indeed threshold of benzaldehyde presented orthonasally significantly decreases with the presence of a saccharin solution in mouth at a subthreshold concentration. The same experiment repeated with sodium monoglutamate does not lead to change of benzaldehyde sensitivity. As for olfactory/taste interaction at a suprathreshold level, interaction at a subthreshold level occurs only with familiar odorant/tastant pair.

These results about the impact of familiarity were confirmed by repeating the same experiment with another panel. However in this case, a lack of integration for the benzaldehyde/saccharine pair was observed for four subjects and may be explain by their low familiarity with this taste/aroma pair. These two studies demonstrate that integration of a subthreshold olfactory stimulus delivered orthonasally with a subthreshold taste was dependent of the subject food experience.

It was also demonstrated an integration of odour and taste at a subthreshold level. This experiment showed that odour/taste integration is not dependent on familiarity. The impact of tastant and odorant are additive, regardless of the harmony of the taste/odour pair. However in this experiment, the odorant is delivered orally in mixture with tastant. To explain difference of results between different studies, one assume that stimulus delivery (orthonasal or retronasal) may play a key role in odorant/tastant interaction.

According to the present invention, it is highlighted whether the impact of an odorant at a subthreshold level could enhance sweetness of a sucrose solution at a suprathreshold level. In our experiments, the odorant was presented orally in sucrose mixture clearly perceived as sweet. The aim of this protocol was to mimic everyday consumption of sweet food. Indeed there is a need for the food industry to enlarge understanding about the impact of olfactory/taste interaction on consumer perception.

The following odorants were selected because of their reported enhancing properties on sweetness at a suprathreshold level: benzaldehyde; ethyl butyrate; furaneol; vanillin and isoamyl acetate. As will be understood in the following, it was found that also all of those ingredients have a positive effect, one of them is more particularly interesting—ethyl butyrate—.

The two following experiments were designed to fulfill our objectives:

Experiment 1: Quantification of the impact at a subthreshold level of ethylbutyrate on sweetness in mineral water (Vittel, France) containg 15% sucrose.

Experiment 2: Validation of the boosting impact on sweetness of subthreshold concentration of ethylbutyrate in a commercial mineral water beverage containing 44% sucrose and a strawberry flavouring

### Experiment 1

### Quantification of the Impact at a Subthreshold Level of ethylbutyrate on Sweetness in Mineral Water (Vittel, France) Containg 15% sucrose

A/ Individual Threshold Measurement and Lowest Threshold of the Panel [LTP] Determination for the Two Odorants Selected Further to the First Experiment:

Fifteen one-liter ethyl butyrate solutions were prepared at room temperature with mineral water (Vittel Bonne Source, France) with odorant concentrations ranging from 0.1 to 5.94 E−06 ppm (=0.1 to 5.94 E−06 mg/l) for ethyl butyrate. Each solution was done one hour prior to the tasting.

A new panel with twelve naïve subjects participated to this experiment. The individual detection threshold was determined by using the Force-Choice Ascending Concentration Series Method of Limit (ASTM, 1991). For each odorant, a series of fifteen 3-alternative forced choice was assessed by the subjects. An ascending concentration range was defined with a dilution factor of 2. The appropriate concentration range was determined further to benchscale preliminary trials. The fifteen 3-AFC were evaluated in an ascending concentration order. Solutions were presented in plastic cup coded with 3-digit random numbers and served at room temperature in a 50-ml cup. Evaluation was conducted in the same conditions as previously described for experiment 1.

For each subject, the concentration above which all AFC tests are correct is considered as the individual detection threshold concentration. The Lowest individual Threshold concentration within the Panel [LTP] was chosen as a basis to determine the subthreshold concentrations used in the next steps of the experiment.

B/ Investigation of the Impact of Odorant at a Subthreshold Level on Sweetness Intensity

To explore the impact of odorant at a subthreshold level on sweet perception, a liquid delivery system was developed. The device was based on a programmable four-channel preparative HPLC pump (Merck-Hitachi, L 7150) and four 1-liter reservoirs. Teflon tubing did the link from the four reservoirs to the HPLC mixing chamber and from the mixing chamber to the subject's mouth. One reservoir (A) contained a sucrose aqueous solution and the two other reservoirs (B and C) contained the same sucrose aqueous solution than inside the reservoir A with two different odorant concentrations. This system allowed to deliver a continuous flow of liquid in mouth with a constant rate and sucrose content but varying in odorant concentration. Compared to experiment 1, sucrose concentration was increased to 15 g/L in order to clearly perceive sweetness when the solution was delivered continuously with the liquid delivery system. In this study, the odorant concentration of the flow delivered in the subject's mouth was programmable by step with two parameters: the 3-channel contributions to the liquid flow composition in percentage and the step duration in seconds. By mixing the three solutions, the device was able to deliver on-line a solution with a wide range of different odorant concentrations.

For each odorant, five concentrations were defined based on [LTP], ([LTP]/16, [LTP]/32, [LTP]/64, [LTP]/128, [LTP]/256) and delivered by mixing the two flavoured solutions with the pure sucrose solution (FIG. 1). The sucrose solution delivered in-mouth at 25 ml/mn was alternatively flavoured and non-flavoured with three increasing odorant concentrations during the first sequence and with two decreasing concentrations during the second sequence. The first sequence was therefore divided into six steps (three flavoured and three unflavoured) and the second sequence was divided into four steps (two flavoured and two unflavoured stimuli) with a total of ten steps for the two sequences (FIG. 1). This flavoured and unflavoured liquid alternation ensured the tubing rinsing between each odorant concentration delivery and limited sensory adaptation. Each of the 10 step was delivered during 18 seconds. The total duration of the two sequences therefore lasted 180 seconds.

The twelve subjects evaluated individually the sequences 1 and 2 during one session with a 180-second break between each sequence. The total amount of liquid swallowed during a session based on the 25 ml/mn flow rate was 75 ml. Each session was duplicated. A total of four sessions per judge was therefore conducted. To standardize among the eleven subjects the liquid delivery in mouth and swallowing, subjects were trained to pinch the Teflon tube extremity between the top and bottom incisives with 1 cm tube into the mouth. The subjects were invited to swallow regularly and normally. They scored overtime the sweet taste intensity at sixteen time points corresponding to the sixteen steps on a 11-box scale anchored at the extremities from “Not sweet at all” to “Very sweet”. A computerized FIZZ session was coupled to the HPLC pump and allowed to synchronize the apparition on screen of the sweetness scale 10 seconds after the beginning of each step. This time period took into account the three seconds needed for the pump to make the mixing and deliver the required concentration. Then the subjects could score the sweetness intensity during the seven remaining seconds. During evaluation, subjects were also asked to report on a sheet of paper any other perception than sweetness (olfactory or gustatory). Moreover a debriefing session was carried out at the end of the second experiment to collect general comments of subjects. After exploring the impact of the two odorants, an additional session was conducted to validate that the sweet enhancement was not due to the device or the procedure. The evaluation of sweetness intensity over time at ten different points was assessed using the 15 g/L sucrose solution but without odorant addition.

Before evaluation sessions, a training consisted in two sessions of habituation were carried out with the device and protocol where subjects got used to receive a constant liquid in mouth combined with a scoring task in a limited time. This training was carried out with unflavoured sucrose solution only.

Sensory data were transformed according to the formula SCn=SOn−Sn where SC is the Sweetness Change, SO the Sweetness of sucrose solution with Odorant and S the Sweetness of sucrose solution without odorant evaluated before SO. Five odorant concentrations (n) were investigated overtime. A confidence interval at 5% was calculated for the five SC panel mean scores.

Threshold concentration ranges within the twelve subjects were for ethyl butyrate from 3.90 E−04 to 3.2 ppm (panel mean: 4.09 E−01 ppm). The lowest individual detection threshold value [LTP] was selected and used for the investigation at subthreshold level i.e. 3.90 E−04 ppm. FIG. 2 represents the change in perceived sweetness (SC) between the unflavoured (S) and the flavoured (SO) sweetened solutions for each ethyl butyrate concentration. All subthreshold concentrations of ethyl butyrate significantly increased the perceived sweetness of the sucrose solution. In addition, the sweetness due to ethyl butyrate subthreshold addition was constant whatever the odorant concentration.

Two explanatory hypotheses can be proposed to explain enhancing impact on sweetness of subthreshold concentrations of ethyl butyrate:

First, ethyl butyrate at subthreshold level enhanced sweetness by perceptual interaction as showed by former experiments.

Second, sweetness enhancement was induced by ethyl butyrate at a suprathreshold concentration because of an increase of the odorant release in headspace due to physical-chemical interaction with sucrose. The second hypothesis was improbable as it had been shown that release of ethyl butyrate present in orange aroma was not enhanced by sucrose (at concentration similar to those used in the present study) compared to the aqueous control. In addition, subjects did not report any other perceived olfactory or gustatory notes different from sweetness during evaluation with the liquid delivery system.

Our first hypothesis is in agreement with recent studies. Indeed odour/taste interaction was reported to result from associations experienced and memorized through food exposure without any explicit attention or learning. Besides, previous studies had highlighted the impact of congruency on olfactory/taste central integration with an orthonasal presentation of the odorant. The role of food experience on sensory interaction at suprathreshold level was also evidenced at a central level. The main outcome of this invention was that sweet taste of a sucrose solution was enhanced by retronasal olfactory perception with odorant even if this odorant was at a subthreshold level.

If validated in real drink or food, this finding may be key in the current food industry context of sucrose content reduction.

### Experiment 2

### Validation of the Boosting Impact on Sweetness of Subthreshold Concentration of Ethylbutyrate in a Commercial Mineral Water Beverage Containing 44% Sucrose and a Strawberry Flavouring

The impact of a subthreshold concentration of ethyl butyrate was evaluated in a commercial beverage (Strawberry Vittel, France) comprising Vittel mineral water with 44% sucrose and a strawberry flavouring (called “ref” in FIG. 3) by a naïve panel of 11 subjects different from the first experiment. This reference was compared to two trials which were a reference with 10% less sucrose and a reference with 10% less sucrose and 2.5 10⁻⁵ mg/l of ethyl butyrate. The two trials were compared to the reference on a −5 to 5 point scale, the reference was arbitrarily at 0 for odour and sweet attribute.

The FIG. 3 represents the panel mean score with the confident interval at 95%. Results showed that the trial with 10% less sucrose was evaluated less sweet than the reference whereas the trial with the same sucrose reduction but containing ethyl butyrate was not significantly different from the reference in terms of sweetness. This result highlighted that the enhancing impact of the subthreshold concentration of ethyl butyrate on sweetness allow a 10% sucrose reduction while keeping the same sweetness.

It should be understood that various changes and modifications to the presently preferred embodiments described herein will be apparent to those skilled in the art. Such changes and modifications can be made without departing from the spirit and scope of the present invention and without diminishing its attendant advantages. It is therefore intended that such changes and modifications be covered by the appended claims.

1. A food composition comprising at least one sugar selected from the group consisting of: natural and artificial sugar that is present in the composition at a suprathreshold concentration, and at least one sweet-enhancing ingredient selected chosen from the group consisting of: benzaldehyde, ethylbutyrate, furaneol, vanillin, isoamylacetate, and a combination thereof, the sweet-enhancing ingredient being present in the composition at a concentration of less than or equal to 2.5·10⁻⁵ mg/l.

2. A food composition according to claim 1, wherein the sweet-enhancing sugar is selected from the group consisting of: simple sugars, hydrogentated sugars, chlorodeoxy sugars, terpenoids or their glycosides, dihydrochalcones, peptides, proteins, nitroanilines, sulphamates oximes, isocoumarins, saccharins, acesulphames, tryptophanes, ureas, and a combination thereof.

3. A food composition according to claim 1, wherein the sweet-enhancing ingredient is present in the composition at a concentration of between 1.5·10⁻⁶ mg/l and 2.5·10⁻⁵ mg/l.

4. A food composition according to claim 1, wherein the sweet-enhancing ingredient is ethyl butyrate.

5. A food composition according to claim 1, wherein the sugar is present in the composition at a concentration of not greater than 50 g/l.

6. A food composition according to claim 1, wherein the food composition is aromatised water.

7. A food composition according to claim 1, which is a chilled dairy plain yoghurt.

8. A food composition comprising:
at least one sugar selected from the group consisting of: simple sugars, hydrogentated sugars, chlorodeoxy sugars, terpenoids or their glycosides, dihydrochalcones, peptides, proteins, nitroanilines, sulphamates oximes, isocoumarins, saccharins, acesulphames, tryptophanes, ureas, and combinations thereof; and
at least one sweet-enhancing ingredient selected from the group consisting of:
benzaldehyde, ethylbutyrate, furaneol, vanillin, isoamylacetate, and combinations thereof, the sweet-enhancing ingredient being present in the composition at a concentration of not greater than 2.5·10⁻⁵ mg/l.
